(19) United States
(12) Patent Application Publication
(10) Pub. No.: US 2026/0046817 A1
(43) Pub. Date: Feb. 12, 2026

(54) USE OF MULTIPLE REFERENCE UES TO SUPPORT LOCALIZATION AND RANGING OF A TARGET UE

(71) Applicant: Samsung Electronics Co., Ltd., Gyeonggi-do (KR)

(72) Inventors: David Gutierrez ESTEVEZ, Middlesex (GB); Mythri HUNUKUMBURE, Middlesex (GB)

(21) Appl. No.: 19/101,402

(22) PCT Filed: Aug. 9, 2023
(86) PCT No.: PCT/KR2023/011767

§ 371 Date: Feb. 5, 2025

(30) Foreign Application Priority Data
Aug. 9, 2022 (GB) 2211618.0
Jun. 28, 2023 (GB) 2309798.3

(51) Int. Cl. H04W 64/00; H04W 24/08; H04W 60/00

(52) U.S. Cl. CPC H04W 64/00; H04W 24/08; H04W 60/00

(57) ABSTRACT

The disclosure relates to a 5G or 6G communication system for supporting a higher data transmission rate. A method of localizing and/or ranging user equipment, UE, in a network, for example a 5G network, including a target UE and a plurality of UEs, the method comprising: assigning, by the network for example by the Location Management Function (LMF) and/or the target UE, the plurality of UEs as multiple reference and/or located UEs; providing, by the multiple reference and/or located UEs to the network for example to the LMF, respective location/range related measurements (also known as location and/or range assistance data) of the target UE; and localizing and/or ranging, by the network for example by the LMF, the target UE using the provided respective location and/or range related measurements of the target UE.

### TECHNICAL FIELD

The present invention relates to networks, for example telecommunication networks.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

There is a need to improve localizing and/or ranging of user equipment, UEs, for example for enhanced Location Services (eLCS) and/or ranging based services in a 5G network.

### DISCLOSURE OF INVENTION

### Technical Problem

It is one aim of the present invention, amongst others, to provide a method and a network which at least partially obviates or mitigates at least some of the disadvantages of the prior art, whether identified herein or elsewhere.

For instance, it is an aim of embodiments of the invention to provide a method and a network that improves localizing and/or ranging of UEs.

### Solution to Problem

A first aspect provides a method of localizing and/or ranging user equipment, UE, in a network, for example a 5G network, including a target UE and a plurality of UEs, the method comprising:
assigning, by the network for example by the Location Management Function (LMF) and/or the target UE, the plurality of UEs as multiple reference and/or located UEs;
providing, by the multiple reference and/or located UEs to the network for example to the LMF, respective location and/or range related measurements (also known as location and/or range assistance data) of the target UE; and localizing and/or ranging, by the network for example by the LMF, the target UE using the provided respective location and/or range related measurements of the target UE.

A second aspect provides a network, for example a 5G network, including a target UE and a plurality of UEs, configured to implement the method according to the first aspect.

### Advantageous Effects of Invention

The present invention provides a method and a network that improves localizing and/or ranging of UEs.

### BRIEF DESCRIPTION OF DRAWINGS

For a better understanding of the invention, and to show how exemplary embodiments of the same may be brought into effect, reference will be made, by way of example only, to the accompanying diagrammatic Figures, in which:

FIG. 1 schematically depicts a method of according to an embodiment of the present disclosure.

FIG. 2 illustrates a configuration of a UE according to an embodiment of the present disclosure.

FIG. 3 illustrates a configuration of a network entity according to an embodiment of the present disclosure.

### MODE FOR THE INVENTION

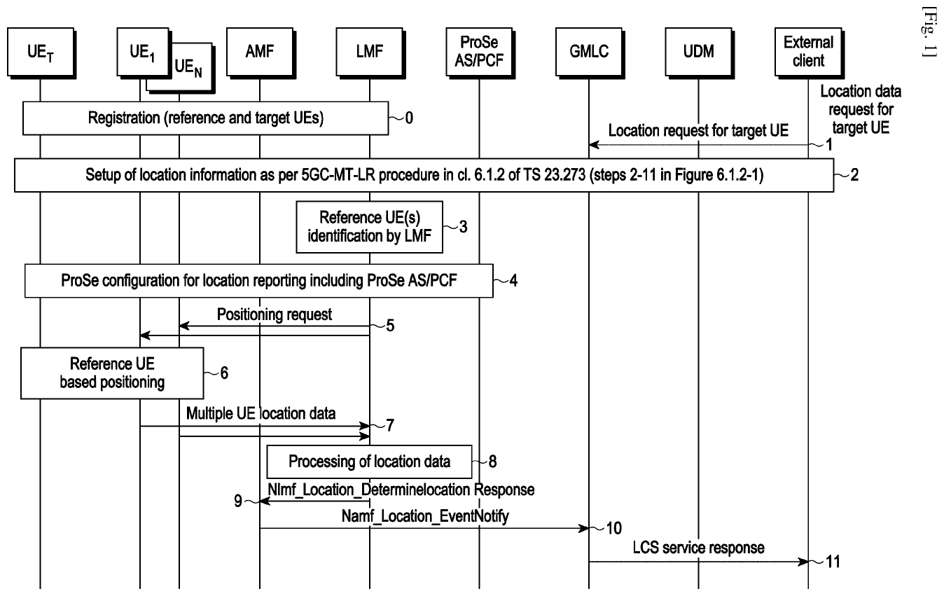

FIGS. 1 through 3, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged system or device.

Hereinafter, the operational principle of the present disclosure is described below with reference to the accompanying drawings. When determined to make the subject matter of the present disclosure unclear, the detailed description of known functions or configurations may be skipped. The terms as used herein are defined considering the functions in the present disclosure and may be replaced with other terms according to the intention or practice of the user or operator. Therefore, the terms should be defined based on the overall disclosure.

As used herein, terms for identifying access nodes, terms denoting network entities, terms denoting messages, terms denoting inter-network entity interfaces, and terms denoting various pieces of identification information are provided as an example for case of description. Thus, the present disclosure is not limited by the terms, and such terms may be replaced with other terms denoting objects with equivalent technical concept.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

According to the present invention there is provided a method, as set forth in the appended claims. Also provided is a network. Other features of the invention will be apparent from the dependent claims, and the description that follows.

The first aspect provides a method of localizing and/or ranging user equipment, UE, in a network, for example a 5G network, including a target UE and a plurality of UEs, the method comprising:
assigning, by the network for example by the Location Management Function (LMF), the plurality of UEs as multiple (i.e. a plurality of) reference and/or located UEs;
providing, by the multiple reference and/or located UEs to the network for example to the LMF, respective location and/or related measurements (also known as location and/or range assistance data) of the target UE; and localizing and/or ranging, by the network for example by the LMF, the target UE using the provided respective location and/or range related measurements of the target UE.

Thus, the respective endpoints for the location related (LPP) messages will be the reference and/or located UEs and the LMF.

The method of localizing and/or ranging according to the first aspect can also be initiated by the target UE. Then, the multiple reference and/or located UEs will provide the location and/or range related measurements and/or the estimated location and/or range of the target UE to the LMF, at the request of the target UE.

The reference and/or located UEs can be defined as UEs that can be located by the LMF by means of positioning via the Uu interface. The Uu interface is the radio interface between the said UE and the 5G gNB.

For localizing a UE, both Uu positioning (between LMF) and sidelink positioning (between UEs) are possible in this invention, while ranging is performed via sidelink positioning mechanisms as it happens only between UEs.

Generally, the use of Device to Device (D2D) or ProSe capability to communicate directly between two short-range devices and derive localization and/or range information (i.e. a location, a geographical location) through this is increasingly being discussed in 3GPP. In some cases, the Location Management Function (LMF) is aware of the general area where the target UE is located, but would not have insights into which reference and/or located UE would have a direct line of sight (LOS) link to provide the best localization and/or range measurements (also known as location measurements) for the target UE. In such cases, especially if the LMF needs location measurements quickly (for example, in ultra-reliable low latency communications (URLLC) applications) assigning multiple reference and/or located UEs simultaneously is the best option. Also, having localization and/or range measurements (like Time Difference of Arrival (TDOA) and/or Time of Arrival (TOA)) from multiple reference and/or located UEs could invariably improve the accuracy of the localization.

This invention focusses on improving the quality of the location and/or range measurements related to a target UE localization and/or ranging, especially in low latency applications. The LMF assigns, for example simultaneously (i.e. concurrently), quasi-simultaneously or successively, multiple reference and/or located UEs in the (for example, vicinity) area of the target UE, the reference UEs provide independent location related measurements, for example quickly, back to the LMF and the LMF has the processing capability to select and combine the best measurements and derive the localization and/or range of the target UE. This invention is particularly useful in dense indoor or urban networks where low latency localization and/or ranging of some UEs or devices is required.

The proposed invention is centred around the use of multiple reference and/or located UEs simultaneously to provide location and/or range measurements of a single target UE back to the LMF. This can be location and/or range measurements conducted in the sidelink, similar to the SL-PRS (Side Link Positioning Reference Signal) in downlink or what multiple gNBs would provide the LMF in SRS (Sounding Reference Signal) measurements in uplink in a default scenario. In this multiple reference and/or located UE solution, the LMF could very well ‘oversubscribe’ the number of reference and/or located UEs and in return it would expect quick responses from the reference and/or located UEs. Also, the LMF will need to have processing capability, to select the best responses and combine them in ways to yield the best location and/or range estimate for the target UE. This enhanced LMF processing capability is also a novel aspect of this invention. This type of solution is best suited to low latency, URLLC applications, where the resources can be oversubscribed, in return for high accuracy and low latency localization results.

It is worth noting that a reference and/or located UE can be co-located with a Positioning Reference Unit (PRU) as defined in TS 38.305 since both entities behave like UEs to the network that assist with the positioning performance of a target UE. As shown in this invention, multiple reference and/or located UEs however can be used towards one single target UE to have multiple measurements/estimations/assistance information sets available at LMF to down select and/or combine them in the most effective way.

Exemplary embodiments covered by this invention include:
The indication to the multiple reference and/or located UEs that multiple such requests have been made. In this way, each of the UE would try to provide the measurement (or assistance data) in the fastest time.
The new processing capability of the LMF—to select and combine different inputs from multiple reference and/or located UEs to derive the best possible location estimate.

In one example, assigning, by the network, the plurality of UEs as the multiple reference and/or located UEs comprises simultaneously assigning, by the network, the plurality of UEs as the multiple reference and/or located UEs.

In one example, the method comprises assigning, by the target UE, the plurality of UEs as the multiple reference and/or located UEs.

In one example, the method comprises identifying, by the network for example by the LMF and/or the target UE, the plurality of UEs to be assigned as the multiple reference and/or located UEs.

In one example, the method comprises requesting, by the network for example by the LMF to the plurality of reference and/or located UEs, the respective location and/or range related measurements of the target UE. Equally, the Target UE could request the reference and/or located UEs to provide the respective location and/or range related measurements to the LMF.

In one example, requesting, by the network for example by the LMF to the multiple reference and/or located UEs, the respective location related measurements of the target UE comprises indicating, by the network for example by the LMF to the multiple reference or located UEs, that the requesting is to the multiple reference and/or located UEs and optionally, requiring the respective location and/or range related measurements of the target UE to be provided with low delay or latency.

In one example, providing, by the multiple reference and/or located UEs to the network for example to the LMF, the respective location and/or range related measurements of the target UE comprises transmitting, by the target UE to the plurality of reference and/or located UEs, location and/or range related measurements thereof, for example over PC5.

In one example, localizing, by the network for example by the LMF, the target UE using the provided respective location related measurements of the target UE comprises combining and/or down selecting the provided respective location and/or range related measurements of the target UE, thereby improving localizing and/or ranging of the target UE.

In one example, the method comprises sending, by the network for example by the LMF to the AMF, GMLC and optionally onwards to the LCS client, a result (i.e. a location and/or ranging of the target UE) of the localizing and/or ranging.

In one example, the method the network comprises and/or is a dense indoor and/or urban network, for example wherein the target UE and at least some of the multiple reference and/or located UEs are located indoors and/or in an urban area.

In one example, assigning, by the network for example by the LMF and/or the target UE, the plurality of UEs as the multiple reference and/or located UEs comprises over-subscribing, by the network for example by the LMF and/or the target UE, the plurality of UEs as the multiple reference and/or located UEs.

In one example, the target UE comprises and/or is a single target UE.

In one example, the method comprises registering the target UE and the plurality of UEs in the network, optionally comprising indicating, by the target UE and the plurality of UEs, respective UE ProSe capabilities of the target UE and the plurality of UEs, registered to the AMF.

In one example, registering the target UE and the plurality of UEs in the network comprises indicating, by the target UE and the plurality of UEs, respective Location Privacy Indications, LPIs, of the target UE and the plurality of UEs.

In one example, assigning, by the network for example by the LMF and/or the Target UE, the plurality of UEs as a plurality of reference and/or located UEs comprises assigning, by the network for example by the LMF, the plurality of UEs as of the multiple reference and/or located UEs based on the respective LPIs.

In one example, the reference and target UEs are registered in the network. The registration may include indications of the UE ProSe capabilities registered to the AMF. These capabilities may include the support for location reporting in addition to other ProSe capabilities. Also the Location Privacy Indication (LPI) defined in TR 38.845 [6] for ProSe based localization can be given by the UE's at this stage, again to the AMF. This enables LMF (through AMF) to identify UEs which can act as reference and/or located UEs.

In one example, the location request for one or multiple UEs from the LCS client arrives at the GMLC. The request may be performed via NEF for untrusted AF requesting UE location.

In one example, the set-up (invocation of AMF and LMF etc.) for location information provision is as per the MT-LR procedure of section 6.2.1 of TS 23.273.

In one example, the LMF identifies one or multiple reference and/or located UE(s) suitable to provide location and/or range information and/or assistance location data related to the target UE.

In one example, the if the ProSe based localization and/or ranging is initiated, the configuration steps are initiated and executed by the ProSe AS/PCF. The LMF will be notified of the outcome of these steps.

In one example, the LMF sends the positioning and/or ranging requests to multiple reference and/or located UEs. Optionally, the request will also indicate that multiple reference and/or located UEs are contacted and to provide the response with low delay.

In one example, the reference and/or located UEs initiate the positioning of the target UE. This can include providing target UE related location measurements and/or assistance data. The target UE will provide the location assistance data (or measurements) to the multiple reference and/or located UEs, potentially over PC5 if ProSe capabilities of the Ues are leveraged.

In one example, the reference and/or located Ues pass on the location assistance data (or measurements) to the LMF, preferably with low latency.

In one example, the LMF processes the data to combine and/or down select multiple inputs from multiple reference and/or located UE to generate the best possible estimate of the target UE location.

In one example, the location response is passed onto AMF, GMLC and then onwards to the LCS client.

In one example, the localization and/or ranging is initiated also by the target UE. Then the selection of the multiple Reference and/or Located UEs will be done by the Target UE. The location and/or range estimation or the measurements will be facilitated by the LMF and conducted over PC5. The results will be passed on to the LMF and thereafter, passed onto AMF, GMLC and then onwards to the LCS client.

The second aspect provides a network, for example a 5G network, including a target UE and a plurality of UEs, for example potential Reference and/or Located UEs, configured to implement the method according to the first aspect.

FIG. 1 schematically depicts a method of according to an exemplary embodiment, showing call flow for Multiple Reference UE led localization. In this example, the steps of the call flow are:
0) The reference and target UEs are registered in the network. The registration may include indications of the UE ProSe capabilities registered to the AMF. These capabilities may include the support for location reporting in addition to other ProSe capabilities. Also the Location Privacy Indication (LPI) defined in TR 38.845 [6] for ProSe based localization can be given by the UE's at this stage, again to the AMF. This enables LMF (through AMF) to identify UEs which can act as reference UEs.
1) The location request for one or multiple UEs from the LCS client arrives at the GMLC. The request may be performed via NEF for untrusted AF requesting UE location.
2) The set-up (invocation of AMF and LMF etc.) for location information provision as per the MT-LR procedure of section 6.2.1 of TS 23.273.
3) The LMF identifies one or multiple Reference UE(s) suitable to provide location information and/or assistance location data related to the target UE.
4) Optionally, if the ProSe based localization is initiated, the configuration steps are initiated and executed by the ProSe AS/PCF. The LMF will be notified of the outcome of these steps.
5) The LMF will send the positioning requests to multiple Reference UEs. Optionally, the request will also indicate that multiple Reference UEs are contacted and to provide the response with low delay.
6) The reference UEs will initiate the positioning of the target UE. This can include providing target UE related location measurements or assistance data. The target UE will provide the location assistance data (or measurements) to the multiple reference UEs, potentially over PC5 if ProSe capabilities of the UEs are leveraged.
7) The reference UEs will pass on the location assistance data (or measurements) to the LMF, preferably with low latency.
8) The LMF will process the data to combine and/or down select multiple inputs from multiple Reference UE to generate the best possible estimate of the target UE location.
9) to 11) The location response will be passed onto AMF, GMLC and then onwards to the LCS client.

It should be understood that the method described with respect to this exemplary embodiment applies to multiple reference and/or located UEs mutatis mutandis. It should be understood that the method applies to localizing and/or ranging mutatis mutandis.

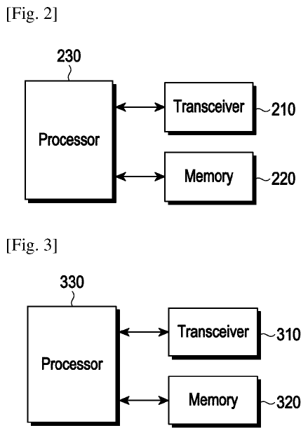

FIG. 2 illustrates a configuration of a UE according to an embodiment of the present disclosure.

As shown in FIG. 2, a UE of the present disclosure may include a transceiver 210, a memory 220, and a processor 230. The processor 230, transceiver 210, and memory 220 of the UE may operate according to the above-described communication methods by the UE. However, the components of the UE are not limited thereto. For example, the UE may include more or fewer components than the above-described components. The processor 230, the transceiver 210, and the memory 220 may be implemented in the form of a single chip.

The transceiver 210 collectively refers to the transmitter of the UE and the receiver of the UE and may transmit and receive signals to/from the base station or network entity. The signals transmitted/received with the base station may include control information and data. To that end, the transceiver 210 may include a radio frequency (RF) transmitter for frequency-up converting and amplifying signals transmitted and an RF receiver for low-noise amplifying signals received and frequency-down converting the frequency of the received signals. However, this is merely an example of the transceiver 210, and the components of the transceiver 210 are not limited to the RF transmitter and the RF receiver.

Further, the transceiver 210 may include a wired/wireless transceiver and may include various components for transmitting/receiving signals.

The transceiver 210 may receive signals via a radio channel, output the signals to the processor 230, and transmit signals output from the processor 230 via a radio channel.

Further, the transceiver 210 may receive the communication signal and output it to the processor and transmit the signal output from the processor to the network entity through the wired/wireless network.

The memory 220 may store programs and data necessary for the operation of the UE. The memory 220 may store control information or data that is included in the signal obtained by the UE. The memory 220 may include a storage medium, such as ROM, RAM, hard disk, CD-ROM, and DVD, or a combination of storage media.

The processor 230 may control a series of processes for the UE to be able to operate according to the above-described embodiments. The processor 230 may include at least one processor. For example, the processor 230 may include a communication processor (CP) that performs control for communication and an application processor (AP) that controls an upper layer, such as an application program.

FIG. 3 illustrates a configuration of a network entity according to an embodiment of the present disclosure.

As shown in FIG. 3, a network entity of the present disclosure may include a transceiver 310, a memory 320, and a processor 330. The processor 330, transceiver 310, and memory 320 of the network entity may operate according to the above-described communication methods by the network entity. However, the components of the network entity are not limited thereto. For example, the network entity may include more or fewer components than the above-described components. The processor 330, the transceiver 310, and the memory 320 may be implemented in the form of a single chip.

The network entity may be implemented as one of the above-described AMF, LMF, ProSe AS/PCF, GMLC, UDM, and External client.

The transceiver 310 collectively refers to the receiver of the network entity and the transmitter of the network entity and may transmit and receive signals to/from a UE or another network entity. In this case, the signals transmitted/received with the base station may include control information and data. To that end, the transceiver 310 may include a radio frequency (RF) transmitter for frequency-up converting and amplifying signals transmitted and an RF receiver for low-noise amplifying signals received and frequency-down converting the frequency of the received signals. However, this is merely an example of the transceiver 310, and the components of the transceiver 310 are not limited to the RF transmitter and the RF receiver. The transceiver 310 may include a wired/wireless transceiver and may include various components for transmitting/receiving signals.

Further, the transceiver 310 may receive signals via a communication channel (e.g., a radio channel), output the signals to the processor 330, and transmit signals output from the processor 330 via a radio channel.

Further, the transceiver 310 may receive the communication signal and output it to the processor and transmit the signal output from the processor to the UE or network entity through the wired/wireless network.

The memory 320 may store programs and data necessary for the operation of the network entity. Further, the memory 320 may store control information or data that is included in the signal obtained by the network entity. The memory 320 may include a storage medium, such as ROM, RAM, hard disk, CD-ROM, and DVD, or a combination of storage media.

The processor 330 may control a series of processes for the network entity to be able to operate according to the above-described embodiments. The processor 330 may include at least one processor. The methods according to the embodiments described in the specification or claims of the present disclosure may be implemented in hardware, software, or a combination of hardware and software.

Although a preferred embodiment has been shown and described, it will be appreciated by those skilled in the art that various changes and modifications might be made without departing from the scope of the invention, as defined in the appended claims and as described above.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of localizing target user equipment (UE) by a located UE in a network, the method comprising:
receiving, from the target UE, information for ranging measurements or estimation results of the target UE; and
transmitting, to a location management function (LMF), the information for ranging measurements or estimation results of the target UE,
wherein the information for ranging measurements or estimation results of the target UE is used to calculate a location of the target UE.

2. The method according to claim 1, wherein the information for ranging measurements or estimation results of the target UE is transmitted from the located UE to the LMF via a serving access and mobility management function (AMF) of the located UE.

3. The method according to claim 1, wherein proximity services (ProSe) capabilities of the target UE and the located UE are registered with an access and mobility management function (AMF).

4. The method according to claim 1, wherein the located UE is a sidelink (SL) reference UE of which a location is known or is able to be known using positioning.

5. A method of localizing target user equipment (UE) by a location management function (LMF) in a network, the method comprising:
receiving, from a located UE, information for ranging measurements or estimation results of the target UE; and
calculating a location of the target UE based on the information for ranging measurements or estimation results of the target UE.

6. The method according to claim 5, further comprising:
identifying multiple located UEs associated with the target UE; and
performing the calculation of the location of the target UE using information from the multiple located UEs.

7. The method according to claim 5, wherein the information for ranging measurements or estimation results of the target UE is received from the located UE to the LMF via a serving access and mobility management function (AMF) of the located UE.

8. The method according to claim 5, wherein proximity services (ProSe) capabilities of the target UE and the located UE are registered with an access and mobility management function (AMF).

9. The method according to claim 5, wherein the located UE is a sidelink (SL) reference UE of which a location is known or is able to be known using positioning.

10. A located user equipment (UE) for localizing target UE in a network, the located UE comprising:
a transceiver; and
a controller coupled with the transceiver and configured to control to:
receive, from the target UE, information for ranging measurements or estimation results of the target UE, and
transmit, to a location management function (LMF), the information for ranging measurements or estimation results of the target UE,
wherein the information for ranging measurements or estimation results of the target UE is used to calculate a location of the target UE.

11. The located UE according to claim 10, wherein the information for ranging measurements or estimation results of the target UE is transmitted from the located UE to the LMF via a serving access and mobility management function (AMF) of the located UE.

12. The located UE according to claim 10, wherein proximity services (ProSe) capabilities of the target UE and the located UE are registered with an access and mobility management function (AMF).

13. A location management function (LMF) for localizing target user equipment (UE) in a network, the LMF comprising:
a transceiver; and
a controller coupled with the transceiver and configured to control to:
receive, from a located UE, information for ranging measurements or estimation results of the target UE, and
calculate a location of the target UE based on the information for ranging measurements or estimation results of the target UE.

14. The LMF according to claim 13, wherein the controller is configured to control to:
identify multiple located UEs associated with the target UE; and
perform the calculation of the location of the target UE using information from the multiple located UEs.

15. The LMF according to claim 13, wherein the information for ranging measurements or estimation results of the target UE is received from the located UE to the LMF via a serving access and mobility management function (AMF) of the located UE.
